(19) United States
(12) Patent Application Publication
(10) Pub. No.: US 2025/0068726 A1
(43) Pub. Date: Feb. 27, 2025

(54) FRAMEWORK FREE INSTRUMENTATION ENGINE

(71) Applicant: Virsec Systems, Inc., San Jose, CA (US)

(72) Inventors: Satya V. Gupta, Dublin, CA (US); Joel Estibeiro, Iblur Village (IN)

(21) Appl. No.: 18/724,275

(22) PCT Filed: Jan. 10, 2023
(86) PCT No.: PCT/US2023/060379

§ 371 Date: Jun. 26, 2024

Related U.S. Application Data
(60) Provisional application No. 63/269,046, filed on Mar. 9, 2022.

(30) Foreign Application Priority Data
Jan. 10, 2022 (IN) 202241001257

(51) Int. Cl. G06F 21/55

(52) U.S. Cl. CPC G06F 21/554; G06F 2221/034

(57) ABSTRACT

In some embodiments, a method includes determining whether a request to a web-based application running at a server is potentially harmful by inspecting the request and interpretations of the request by the web-based application. If the request of the web-based application is potentially harmful, the method issues a protection action to the web-based application. The protection action can be a mitigation measure such as stopping the request from being run at the user system, stopping the user request from being run in the server, denying the user request from read access to a database, and/or denying the user request from write access to a database.

### RELATED APPLICATIONS

This application claims the benefit of U.S. Provisional Application No. 63/269,046, filed on Mar. 9, 2022.

This application claims priority under 35 U.S.C. § 119 or 365 to India application Ser. No. 202241001257, filed Jan. 10, 2022.

The entire teachings of the above applications are incorporated herein by reference.

### BACKGROUND

Requests, e.g., TCP/UDP based requests, can be issued from user systems to web-based applications over a network, e.g., a private cloud, a public cloud, and/or a data center, amongst other examples. These requests include user data, are processed by the web-based applications, and often perform a task on the server or return data to the user system over the network.

### SUMMARY

In some embodiments, a method includes determining whether a request to a web-based application running at a server is harmful (or potentially harmful) by inspecting the request and interpretations of the request by the web-based application. For instance, an embodiment determines if an attacker is using carefully crafted data in the request that a vulnerable web-based application converts into code which executes as a malicious child process. If the request of the web-based application is potentially harmful, the method issues a protection action to the web-based application. The protection action can be a mitigation measure such as stopping the request from being run at the user system, stopping the user request from being run in the server, denying the user request from read access to a database, and/or denying the user request from write access to a database. In another embodiment, the mitigation measure includes pushing security control code to a system used to send the request.

In some embodiments, the method further includes determining whether an interpreter (including any Living Off the Land Binary (LOLBIN) that enables bad actor malicious code to execute) execution status that is potentially harmful if the request is successfully run by the application or unsuccessfully run. An embodiment may determine if malicious data in the request is turned into code that causes a malicious action. The method further includes labeling the request as an attack if it is successfully run and labeling the request as a threat if it is unsuccessfully run.

In some embodiments, the method further includes determining whether an interpreter syntax in response status that is potentially harmful if the request is successfully run by the application or unsuccessfully run. The method further includes labeling the request as an attack if it is successfully run and labeling the request as a threat if it is unsuccessfully run.

In some embodiments, the request is a user request, e.g., a HTTP request or end-user request, amongst other examples.

In some embodiments, determining whether the request is potentially harmful includes: determining that interpreter syntax is in the request and that user input is in the interpreter input.

In some embodiments, the method further includes hijacking, i.e., hooking, the system call table of the server. Hijacking the system call table of the server can include replacing the system call table with a system call table that enables running the security logic disclosed in the web-based application, optionally interfacing with an analysis module to do So.

In some embodiments, the method further includes analyzing at least one of arguments and return value of system calls being traced by the server.

In some embodiments, the determining step occurs in a modified system call table in a kernel of an operating system, the system call table running with preemption enabled.

In some embodiments, preemption being enabled further enables (i) using semaphores, (ii) allocating large amounts memory, (iii) processing input-output to make the code dynamic, and (iv) protecting critical sections.

In some embodiments, the modified system call can be applied to multiple distributions and versions of any operating system.

In some embodiments, the injected code of any size can be detected by the modified system call table.

In some embodiments, the determining and issuing steps are performed within the kernel.

In some embodiments, the steps being performed within the kernel avoids context switching or waiting for a response from user space.

In some embodiments, the method further includes receiving the request over a network from a user system and after the determination, responding to the request to the user system.

In some embodiments, the interpreter is a logical program, e.g., a handler (that can invoke an interpreter) or application specific business logic, amongst other examples.

According to an embodiment, the request is potentially harmful if data in the request is turned into code by the web-based application. For instance, such an embodiment may determine that malicious data in the request contains code and/or data with a syntax that is treated as code, by an interpreter or LOLBIN of the web-based application.

In some embodiments, a system includes a processor and a memory with computer code instructions stored thereon. The processor and the memory, with the computer code instructions, are configured to cause the system to determine whether a request to a web-based application running at a server is potentially harmful by inspecting the request and interpretations of the request by the web-based application. The processor is further configured to, if the request of the web-based application is potentially harmful, issue a protection action to the web-based application.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram illustrating some example embodiments of the present disclosure.

FIG. 2 is a flow diagram illustrating an example embodiment of the present disclosure.

FIG. 3 is a diagram illustrating an embodiment of implementing the system call table to provide the following method to a system.

FIG. 4 illustrates a computer network or similar digital processing environment in which embodiments of the present invention may be implemented.

FIG. 5 is a diagram of an example internal structure of a computer (e.g., client processor/device or server computers) in the computer system of FIG. 4.

### DETAILED DESCRIPTION

A description of example embodiments follows.

In web-based applications, a user connects to a server of the web-based application. Often, the web-based application creates a session specific to the user (e.g., authentication) in a session layer specific to the user. The session is initiated by a request that includes information such as, in the example of an HTTP request, a HTTP request line, headers (e.g., the arrangements between end points, type of browser or device, and data returned or sent). The request traverses through the application, e.g., through an HTTP pipeline, where the server analyzes the request, runs logic, and generates a downstream response. The logic can be, in embodiments, an SQL request.

Detection of cyberattacks originating from an outside network (e.g., the Internet or the cloud) can be difficult to detect, and therefore deter. One reason for this difficulty is because web-based applications routinely generate byte code in a system's local memory. An attacker can leverage a vulnerability in the web-based application's logic to “generate” attacker-controlled code directly in memory. For example, an SQL injection attack can force a command to the business logic through user data. Therefore, it is desirable to distinguish attacker-controlled code from application provided code.

To make a distinction between attacker-controlled code and application provided code, contextual instrumentation can be deployed at strategic locations in the application framework. The contextual instrumentation allows the security control to follow the journey as the attacker provided data is processed by the application's business logic, and the corresponding code is generated by the application. One marker of a web attack occurs when attacker provided data contains verbs (e.g., SQL verbs) from one or more interpreters that the application's business logic depends on, and the application's business logic blindly trusts the said data as being benign. For example, an attacker can slip in SQL Verbs as data. A vulnerable application may trust such “data” and fold this data into the SQL statement it is expected to generate.

Inserting specific instrumentation strategically into each framework's existing code base can become tedious and difficult to maintain as the framework's code evolves over time. As more time passes, the number of programming languages and the number of software frameworks increases, making the job of instrumenting each of these infeasible.

In some embodiments, the present disclosure provides an instrumentation engine that is independent (e.g., not reliant) on the underlying framework implemented on the server. This significantly reduces the time and resources spent in instrumenting each framework individually. Therefore, the present disclosure provides a protection solution that is only dependent on the underlying operating system.

As stated previously, a web-based application routinely accepts user input (e.g., a HTTP request) and converts it, in real time, into code for downstream interpreters (e.g., SQL Interpreter, OS Command Interpreter, Java interpreter, XML interpreter, etc.). Such code is dispatched to a remote interpreter using standard inter-process communication (IPC) means (e.g., shared memory, TCP/IP, named pipes etc.). This inter-process communication is achieved using system calls. For example, TCP/IP communication is achieved using the send and receive system calls, but a person of ordinary skill in the art can appreciate that other protocols can be employed.

Web servers typically process input of each user synchronously using a run-to-completion model. This means that a web-based application spawns a worker thread which synchronously performs the various operations subsumed in the user's input.

Therefore, by collecting the data from the system calls made on each worker thread in real time, a method can observe the user “data” and the corresponding “code” generated by the application in context. From these observations, the method can detect when an attacker influenced the interpreter when specific verbs reach the interpreter. The method can also determine the execution status of such a system call.

Such synchronous data is next sent to an analysis engine that employs a truth table to determine in real time if the application-generated user-influenced code is malicious.

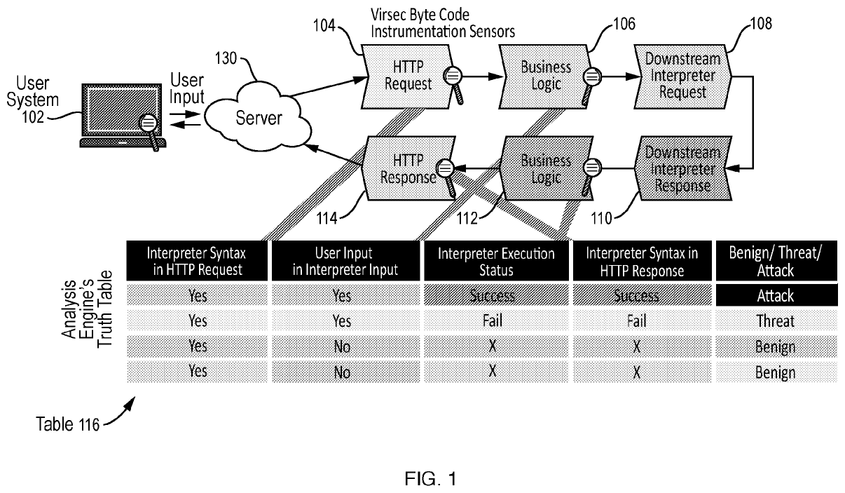

FIG. 1 is a block diagram 100 illustrating some example embodiments of the present disclosure. It is noted that while the example of FIG. 1 processes an HTTP request, embodiments are not limited to processing HTTP requests and, instead, embodiments may determine if any type of request to a web-based application is malicious. In establishing a session with a web-based application, a user system 102 sends user input 120 to a server 130 over a network. In this example, the server 130 processes the user input as an HTTP request 104. The server's 130 business logic 106 is applied to the HTTP request 104 to generate a downstream interpreter request 108. The downstream interpreter request 108 is processed by the server to create a downstream interpreter response 110. The downstream interpreter response is also analyzed by the business logic 112 and converted to an HTTP response 114 that is returned to the user system 102.

In some embodiments, the user system 102 and server 130 interaction can be analyzed by logic as illustrated by the logic table 116. The HTTP request 104 is analyzed (e.g., at the TCP/IP level) to determine whether there is interpreter syntax in the HTTP Request 104. For example, the analysis can determine whether there is SQL code within a provided user name or other data field that could be interpreted downstream as code.

The business logic 106 (e.g., application code) is analyzed to determine whether the user input 120 is in the interpreter input. In other words, the business logic 106 is analyzed to determine whether the user input 120, as converted into an SQL or other code command, is in that command. Then the business logic 112 is analyzed to determine whether the interpreter execution status is successful or whether the command failed. Finally, the HTTP Response 114 is analyzed to determine whether the Interpreter syntax is in the HTTP response and whether that was successful or failed.

Logic table 116 receives the inspections of the above analyses of the HTTP request chain and determines whether a request is benign, a threat, or an attack. A benign request poses no danger to the system. A threat indicates that user input entered interpreter code, but did not successfully execute. An attack indicates that the user input entered interpreter code and did/would successfully execute.

If there is no interpreter syntax in the HTTP Request 104 (e.g., first column), there the user input 120 is benign. However, if interpreter syntax is detected, the logic table 116 analyzes whether the user input was taken into the interpreter input (e.g., SQL command). If not, the HTTP Request 104 is handled correctly by the business logic and is benign. If the user input is taken into the interpreter input, then the request is either an attack or a threat. Then, both the interpreter execution status and interpreter syntax in the HTTP response are analyzed to determine whether the execution at the interpreter 112 and HTTP response 114 are successful or failed. If successful, it is considered an attack, and if failed, it is considered a threat.

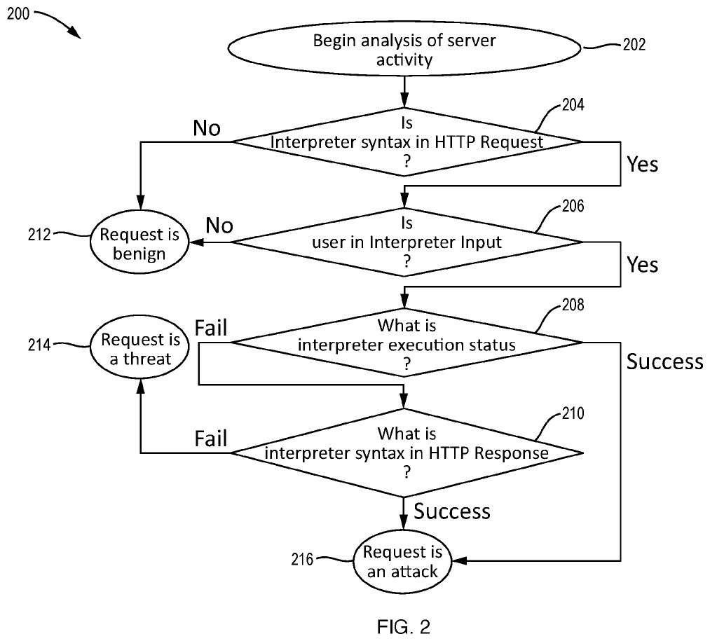

FIG. 2 is a flow diagram 200 illustrating an example embodiment of the present disclosure. The flow diagram 200 illustrates the logic of the logic table 116. In reference to the flow diagram 200 of FIG. 2, the method begins analyzing server activity (e.g., an HTTP request at a web-based application) (202). The server analyzes the activity to determine whether interpreter syntax is in the HTTP request (204). If not, the request is considered benign (212). If so, the request is further analyzed to determine whether user input got into the interpreter input through the business logic/application logic (206). If not, the request is benign (212). If so, the interpreter execution status (e.g., whether the interpreter can correctly run the code) is analyzed. If it is successful, the request is considered an attack (216). If it fails, however, the request is analyzed to determine whether the interpreter syntax in the HTTP response (208). If the interpreter syntax is in the HTTP response (208), then the request is an attack (216), and if not, the request is a threat (214).

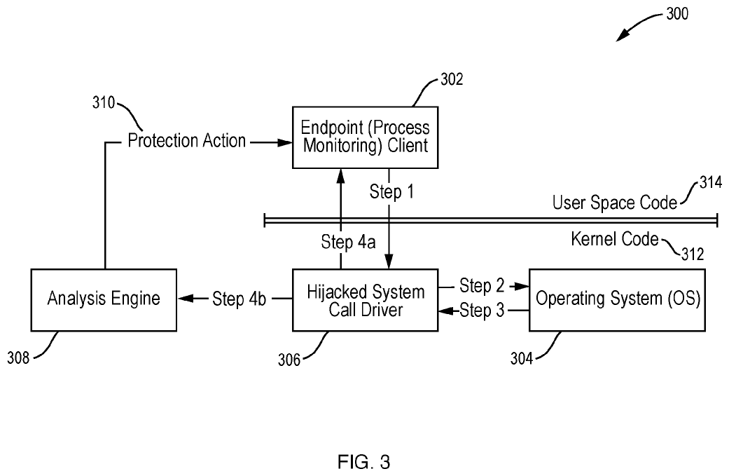

FIG. 3 is a diagram illustrating an embodiment of implementing the system call table to provide the following method to a system. The system can be a Linux, Windows, or MacOS system, or any other operation or distribution of operating system. While below embodiments are described in relation to Linux, it can be understood that other operating systems can be used.

### Instrumenting System Call Table

Whenever a Linux (or other operating system) distribution boots up, a system call table is loaded into the kernel memory. The system call table is essentially a table of function pointers that guides an incoming system call from the user space to the appropriate kernel function that handles it. For example, if the ‘read’ system is called from the user space, the kernel calls the function corresponding to the ‘read’ system call (e.g., the ‘sys_read’ function).

### Controlling the System Call Table

In some embodiments, once the address of the system call table is found using the “kallsyms_lookup_name” function, the pointers in the table are arranged according to system call numbers defined in the “linux/syscalls.h” header file. In some embodiments, the method can overwrite the table with desired functions to be able to intercept any system call.

To get the appropriate telemetry, the operating system's 304 System Call table is instrumented with a hijacked or modified system call table 306 for those system calls that service user input (e.g., user input of step 1). The code can then be sent to other IPC endpoints such as the various interpreters in the application.

### Intercepting Incoming Traffic

In some embodiments, a web server application, or endpoint (process monitoring) client 302 running on a server that takes some input from the user can also be a possible entry point for an attacker. In some embodiments, the method makes sure that the given input is clean and non-malicious before processing it at the server. Many web servers have their own application programming interface (API) to process incoming data packets (e.g., HTTP requests) depending on the underlying programming language of the framework. In a non-limiting example, the framework can be written in C. For inbound connections, C uses the accept ( ) function to establish a socket for incoming connections which internally calls the “accept” system call. This transfers control to the function “sys_accept4” from the system call table that exists in kernel memory. Similarly, incoming data is read using the read ( ) function which takes the file descriptor returned by accept ( ) as an argument. read ( ) internally calls the “read” system call which in turn calls the “sys_read” kernel function.

If these particular kernel functions were instrumented, rather than instrumenting the framework API, the method can instrument any type of framework as long as it is running on a Linux machine. This can be done by controlling, or hijacking, the system call table.

In some embodiments, the method writes a custom function in a kernel module that executes the “sys_accept4” function and saves the returned file descriptor. Another custom function can check the file descriptor of the “sys_read” call, match it to the one returned by “sys_accept4” and check the validity of the received data. Once verified, the method either proceeds with normal execution by calling the original function with the original arguments or terminates the process and exit. These custom functions in the kernel code 312 are implemented by the hijacked system call driver, and interfaces with the Operating system (OS) 304 and Analysis Engine 308 (which executes the table 116 of FIG. 1 and flowchart of FIG. 2). If the analysis engine 308 determines a threat or attack, it can issue a protection action 310 to the endpoint client 302.

### Current Methods

### Kprobes

Kprobes allows for installation of pre-handlers and post-handlers for any kernel instruction as well as for function-entry and function-return handlers. Handlers get access to registers and can alter them. Kprobes allow for the possibility of both monitoring the work process and altering that process. System Tap is an example of a dynamic instrumentation tool for the Linux kernel that internally uses kprobes by default.

However, Kprobes is only a tool for setting a breakpoint at a particular place in the kernel. To get function arguments or local variable values, one needs to know where exactly on the stack and in what registers they are located.

Even though it is a one-time procedure, positioning breakpoints is quite costly. While breakpoints do not affect the rest of the functions, their processing is also relatively expensive. While the costs of using kprobes can be reduced significantly by using a jump-optimization implemented for the x86_64 architecture, the cost of kprobes surpasses that of modifying the system call table. Kprobes involves a lot of context switches and constantly saving and retrieving hardware registers. So, to perform synchronization, all handlers need to be executed with a disabled preemption. As a result, there are several restrictions for the handlers: waiting in them is disabled, and as a consequence, large amounts of memory cannot be allocated, input-output cannot be processed, sleep in semaphores and timers is disabled, etc.

eBPF (Extended Berkeley Packet Filter)

eBPF allows execution of sandboxed programs within the operating system which enables application developers to run eBPF programs to add additional capabilities to the operating system at runtime. The operating system then guarantees safety and execution efficiency as if natively compiled with the aid of a Just-In-Time (JIT) compiler and verification engine. System Tap itself has an option to insert custom code using a eBPF backend.

The biggest limitation of eBPF is that it is restricted to recent versions of the Linux kernel. Making full use of eBPF requires a kernel version of 4.4 and above. This makes it difficult to implement in older Linux distributions that are still in use.

The size of an eBPF program is limited to a maximum of 4096 bytes, which ensures the program terminates without an unbounded loop. This also limits the resources a program can have access to, and the functionality that can be implemented with the programs. Therefore, eBPF programs tend to be very small.

### Custom Implementation Introducing a User Space Component

In some other methods, the system call table is hijacked, but the decision to suspend the process is made by a concurrently running user space application. Memory is shared between the kernel module and the user space application using the “mmap” system call and mapping the memory allocated by the kernel module in the address space of the user space application. Data was shared in this memory by use of circular buffers.

The entire flow of the implementation begins when an incoming or outgoing system call is intercepted, and the data is stored in a “syscall” object and added to the “system call ring buffer”. This thread then waits for a decision to be made. The user space application that is running concurrently notices this entry and attempts processing. The user space application analyses the system call data (e.g., arguments and return value) and the past system call data of the calling thread and decides on whether it should kill the thread or allow it to run. This decision is then stored in a “response” object and added to the “response ring buffer”. A separate kernel thread then picks this response up and depending on what the response is, either lets the calling thread proceed or terminates the thread.

A first disadvantage with this approach was the waiting. The calling thread must wait for a decision which turned out to be expensive when run against a benchmark. Another limitation or disadvantage is that this implementation involves a lot of context switching between kernel threads and user space threads which also had a heavy impact over the performance of the project

By contrast, the system presented in this application provides several advantages. First, by hijacking the system call table, embodiments of the method can obtain, and store for further analysis, the arguments and return value of every system call that is being traced.

Second, the attached code runs with preemption enabled, which enables embodiments to use semaphores, allocate huge chunks of memory, process input-output to make the code more dynamic and protect critical sections.

Third, modifying the system call table is extremely cost efficient.

Fourth, the present method can be applied to old and new versions of the Linux kernel.

Fifth, there is no restriction on the size of the injected code because embodiments are overwriting the system call table itself.

Sixth, all of the decision making is done within the kernel itself therefore avoiding the need for context switching and/or waiting for a response from the user space.

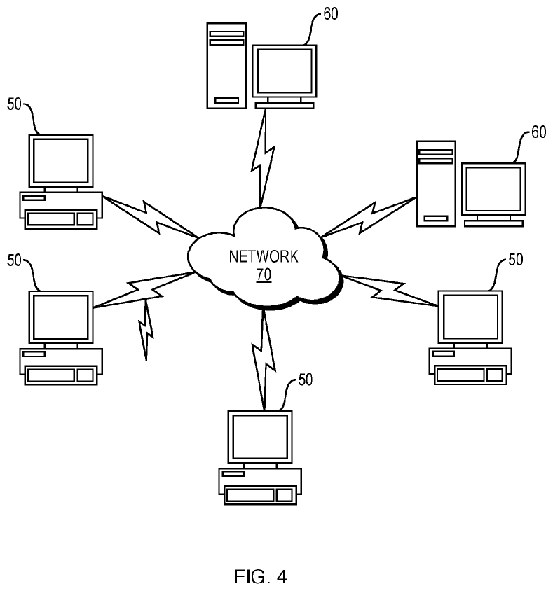

FIG. 4 illustrates a computer network or similar digital processing environment in which embodiments of the present invention may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

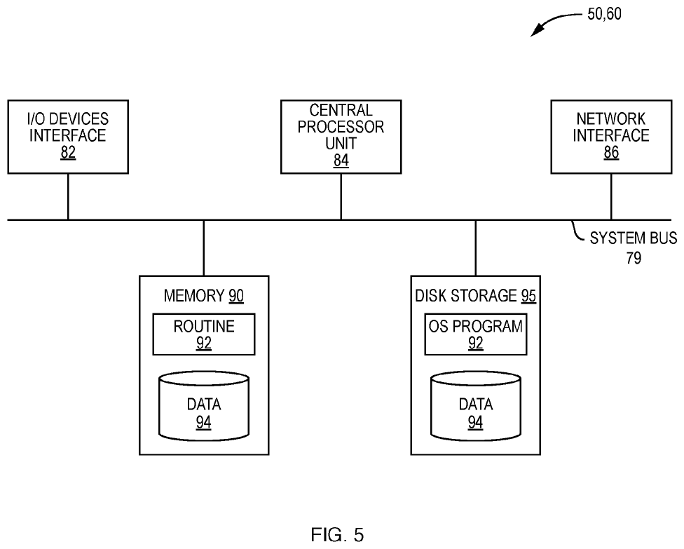

FIG. 5 is a diagram of an example internal structure of a computer (e.g., client processor/device 50 or server computers 60) in the computer system of FIG. 4. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 4). Memory 90 provides volatile storage for computer software instructions 92 and data 94 used to implement an embodiment of the present invention (e.g., web application module, system call driver module, and hijacked or modified system call driver module, analysis module code detailed above). Disk storage 95 provides non-volatile storage for computer software instructions 92 and data 94 used to implement an embodiment of the present invention. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present invention routines/program 92.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A method comprising:
determining whether a request to a web-based application running at a server is potentially harmful by inspecting the request, and interpretations of the request by the web-based application;
if the request of the web-based application is potentially harmful, issuing a protection action to the web-based application.

2. The method of claim 1, further comprising:
determining whether an interpreter execution status that is potentially harmful if the request is successfully run by the application or unsuccessfully run;
labeling the request as an attack if it is successfully run;
labeling the request as a threat if it is unsuccessfully run.

3. The method of claim 1, further comprising:
determining whether an interpreter syntax in response status that is potentially harmful if the request is successfully run by the application or unsuccessfully run;
labeling the request as an attack if it is successfully run;
labeling the request as a threat if it is unsuccessfully run.

4. The method of claim 1, wherein the request is an user request.

5. The method of claim 1, wherein determining whether the request is potentially harmful includes:
determining that interpreter syntax is in the request and that user input is in the interpreter input.

6. The method of claim 1, further comprising hijacking a system call table of the server.

7. The method of claim 1, further comprising:
analyzing at least one of arguments and return value of system calls being traced by the server.

8. The method of claim 1, wherein the determining step occurs in a modified system call table in a kernel of an operating system, the system call table running with preemption enabled.

9. The method of claim 8, wherein preemption being enabled further enables use of semaphores, allocating large amounts of memory, processing input-output to make the code dynamic and protect critical sections.

10. The method of claim 8, wherein the modified system call can be applied to multiple distributions and versions of any operating system.

11. The method of claim 8, wherein injected code of any size can be detected by the modified system call table.

12. The method of claim 8, wherein the determining and issuing steps are performed within the kernel.

13. The method of claim 12, wherein the steps being performed within the kernel avoids context switching or waiting for a response from user space.

14. The method of claim 1, further comprising:
receiving the request over a network from a user system; and
after the determination, responding to the request to the user system.

15. The method of claim 1, wherein the interpreter is a logical program.

16. The method of claim 1, wherein the protection action is a mitigation measure such as stopping the request from being run at the user system, stopping the user request from being run in the server, denying the user request from read access to a database, and/or denying the user request from write access to a database.

17. The method of claim 1 wherein the request is potentially harmful if data in the request is turned into code by the web-based application.

18. A system comprising:
a processor; and
a memory with computer code instructions stored thereon, the processor and the memory, with the computer code instructions, being configured to cause the system to:
determine whether a request to a web-based application running at a server is potentially harmful by inspecting the request, and interpretations of the request by the web-based application;
if the request of the web-based application is potentially harmful, issue a protection action to the web-based application.

19. The system of claim 18, wherein the processor is further configured to:
determine whether an interpreter execution status that is potentially harmful of the request is successfully run by the application or unsuccessfully run;
label the request as an attack if it is successfully run;
label the request as a threat if it is unsuccessfully run.

20.-34. (canceled)

35. A computer program product comprising:
one or more non-transitory computer-readable storage devices and program instructions stored on at least one of the one or more storage devices, the program instructions, when loaded and executed by a processor, cause an apparatus associated with the processor to:
determine whether a request to a web-based application running at a server is potentially harmful by inspecting the request, and interpretations of the request by the web-based application;
if the request of the web-based application is potentially harmful, issue a protection action to the web-based application.
